(19) United States
(12) Patent Application Publication
(10) Pub. No.: US 2026/0006039 A1
(43) Pub. Date: Jan. 1, 2026

(54) AUTOMATIC INCIDENT IDENTIFICATION, INVESTIGATION, AND NEXT-STEP PREDICTION

(71) Applicant: MICROSOFT TECHNOLOGY LICENSING, LLC, Redmond, WA (US)

(72) Inventors: Andrey KARPOVSKY, Kiryat Motzkin (IL); Tamer SALMAN, Haifa (IL); Moshe ISRAEL, Redmond, WA (US); Fady COPTY, Haifa (IL)

(21) Appl. No.: 18/755,596

(22) Filed: Jun. 26, 2024

(51) Int. Cl. H04L 9/40

(52) U.S. Cl. CPC H04L 63/1416; H04L 63/1433

(57) ABSTRACT

The disclosed techniques automatically identify cyber-security attacks and predict attack next steps. Descriptions of previously observed cyber-attack campaigns are decomposed into attack campaign steps. Real-time security incident signals are generated by cybersecurity software. Attack campaigns are identified by mapping attack campaign steps to security incident signals. Custom-generated telemetry queries are executed to determine if a missing attack campaign step occurred. A machine learning model generates embeddings for attack campaign steps, security incident signals, and telemetry query responses. A security incident signal or a telemetry query response matches an attack campaign step when their embeddings are within a defined distance. A security alert may be raised when most or all of the attack campaign steps of a particular attack campaign are matched. Attack campaign steps that are not matched to security incident signals or telemetry query results are predicted as attack next steps.

### BACKGROUND

In the digital age, the security of computer systems is paramount. As technology advances, so do the techniques and methods employed by malicious actors to compromise these systems. Cyber-attacks pose significant risks to individuals, businesses, and governments, leading to severe financial, operational, and reputational damage.

It is with respect to these and other considerations that the disclosure made herein is presented.

### SUMMARY

The disclosed techniques automatically identify cyber-security attacks and predict attack next steps. Descriptions of previously observed cyber-attack campaigns are decomposed into attack campaign steps. Then, real-time security incident signals are generated by cybersecurity software. Attack campaigns are identified by mapping attack campaign steps to security incident signals. When a attack campaign step does not map to a security incident signal a custom-generated telemetry query is executed to determine if the attack campaign step occurred. A machine learning model generates embeddings for attack campaign steps, security incident signals, and telemetry query responses. A security incident signal or a telemetry query response matches an attack campaign step when their embeddings are within a defined distance. A security alert may be raised when most or all of the attack campaign steps of a particular attack campaign are matched. Attack campaign steps that are not matched to security incident signals or telemetry query results are predicted as attack next steps.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates generating a security incident signal.

FIG. 2 illustrates detecting anomalous behavior of a target computing device.

FIG. 3 illustrates detecting a vulnerability of a target computing device.

FIG. 4 illustrates decomposing an attack campaign description into attack campaign steps.

FIG. 5A illustrates matching security incident signals to attack campaign steps.

FIG. 5B illustrates matching a telemetry query response to attack campaign steps.

FIG. 6 is a flow diagram of an example method for automatic incident identification, investigation, and next-step prediction.

FIG. 7 is a computer architecture diagram illustrating an illustrative computer hardware and software architecture for a computing system capable of implementing aspects of the techniques and technologies presented herein.

### DETAILED DESCRIPTION

### Cybersecurity Challenges

Hackers are continually evolving their tactics to outmaneuver cyber-security measures. One strategy is to understand and circumvent security incident signal thresholds. For example, attackers may adapt to a number of allowed login attempts, rate limits on data access, and other anomaly detection parameters. Strategically avoiding these thresholds allows a hacker to continue their attack undetected.

Another strategy employed by hackers is to leverage vulnerabilities that have been recently discovered but not yet mitigated. Security researchers disclose security vulnerabilities every day. It is an ongoing challenge to develop identification and mitigation strategies to these vulnerabilities in a timely manner and without negatively impacting the utility of the system.

Another challenge faced by security engineers is distinguishing legitimate use from malicious activity. As attackers become more sophisticated, they increasingly mimic legitimate user behavior to evade detection. This makes it difficult for security systems to accurately differentiate between normal operations and potential threats, leading to false positives and false negatives. For example, a remote login from a new IP address in a new geographic region may be an attacker using stolen credentials or an employee logging-on while on vacation.

### Threat Intelligence

At the same time, security researchers are engaged in an ongoing effort to identify and catalog cyberattacks. The result is an extensive body of threat intelligence—a corpus of descriptions of attack practices. These attack reports may be generated by security researchers around the globe as new attack techniques are identified, enabling organizations to stay up-to-date on the latest threats.

One way to describe attacks is in terms of Indicators of Compromise (IoC)-rule-based descriptions of the attack campaign steps of a cyber-attack. Example indicators of compromise include IP-address, file hash, and process name. For example, a phishing attack may be described with four indicators of compromise: an indication that an email was received, the title of the email, the domain the email was sent from, and an indication that the email was attempting to acquire information from a set of links. Indicators of compromise data is structured—it is labeled with names and types that describe what the data means. For example, an indicator of compromise that describes the domain of an email address may use JSON, XML, or some other data exchange format to represent the domain name. For instance, the domain name may be encoded as a string field of a JSON object named “domain_name”.

However, reliance on concrete rules leaves systems vulnerable to detection-evasion techniques discussed above. For example, attackers will change IP addresses or time login attempts to fall within expected parameters.

Indicators of compromise are also unable to represent the full spectrum of knowledge gained about an attack. For example, some attackers might prefer a naming convention that can be recognized, but this is hard to formulate as an indicator of compromise rule. Without this context, researchers are more likely to resort to further manual investigation of system logs and other low-level telemetry data to determine whether an attack occurred.

In light of these limitations, reports of cyber-attacks are often augmented with a natural language description. For example, a list of IP addresses that have been involved in an attack is an IoC that may be combined with a written description of the attack. In some cases the written description may be semi-structured, such as by presenting a list of attack campaign steps taken by an attack. Attack reports may come in the form of a blog post, documentation of a penetration testing tool, or other exposition that has a written description component.

### Attack Description Steps are Matched to Security Incident Signals

In some configurations, machine learning models decompose attack campaign descriptions, alone or in conjunction with indicators of compromise, into attack campaign steps. Models are also used to generate embedding representations of these attack campaign steps. Attack campaign steps are matched with security incident signals, which may be observed in real-time on a computing device or from a telemetry log.

Security Incident Signals are Derived from Telemetry Data

Security software is often implemented with a tiered architecture. The lowest level captures and records telemetry data—information obtained as an application runs. Telemetry data, such as a telemetry log, is a verbose collection of trace data captured while a computing device operates. For example, a web commerce website may record when users login or logout, including the user's username, their IP address, the operation they were performing, etc.

While useful when defending against attackers, telemetry logs are verbose, and a vast majority of data that is logged represents legitimate usage. As such it can be difficult to distinguish an attack from mundane access. One technique for distinguishing legitimate usage from an attack is to generate alerts based on the telemetry data. Alerts are a type of security incident signal that identify suspicious patterns in telemetry data. Security organizations may define alerts in different ways according to their specific applications, their history of experiencing cyber-attacks, their risk tolerance, among other factors.

For example, an organization may raise an alert when a web request's IP address is deemed anomalous or malicious, or if a computing device downloads malware. For instance, if an application normally receives connections from IP addresses in the United Kingdom, but a particular request originates from Belgium, this discrepancy may be used to generate an alert. Alerts may also be based on combinations or other patterns found in telemetry data, such as a combination of a particular operation and receiving a web request from an uncommon IP address. Analyzing telemetry data to identify alerts converts verbose telemetry data that contains data of mostly legitimate usage to security incident signals that are rare indications of something suspicious.

Alerts are one example of a security incident signal. A security incident signal refers to an operation or configuration of a computing device that suggests the possibility of a security threat. Alerts are warnings generated by analyzing the content of telemetry logs or other streams of device activity. Alerts are often generated for human consumption, creating tension between the goal of providing comprehensive knowledge with the goal of avoiding frivolous alerts and false positives.

### Vulnerabilities

Vulnerabilities are another kind of security incident signal—a posture or a configuration of a computing device that puts it at risk. In contrast with an alert, a vulnerability does not indicate that anything has happened. Rather, a vulnerability is an indication of a state of the computing device. Examples of vulnerabilities include weak passwords, a virtual machine that is exposed to the internet, etc. In some configurations, combinations of vulnerabilities may be identified, such as a computing device with a weak password that is also exposed to the internet. An attack campaign description may indicate that the attack is more likely to succeed when a target device has a particular vulnerability. Threat analysis may be adjusted accordingly, such as by increasing detection sensitivity when a vulnerability puts the target device at greater threat.

### Behavioral Anomaly

A behavioral anomaly is another kind of security incident signal. Behavioral anomalies occur when a normal operation exceeds typical usage patterns. For example, data exfiltration is often performed to backup files. As such, a given data exfiltration operation is likely legitimate. However, large volumes of exfiltration can have security implications, and so detection sensitivity may be increased when an observed behavioral anomaly increases the likelihood that an attack is in progress.

Matching Attack Description Steps with Security Incident Signals

While alerts are crafted to be rare, a large organization may observe tens or hundreds or more alerts per week. It is an ongoing problem to correlate security incident signals generated by an organization's computing devices, such as alerts, to known attack patterns described in threat intelligence literature.

Attack campaign steps may be mapped to security incident signals using semantic search. The models used to generate embedding representations of attack campaign steps are used to generate embeddings of security incident signals. An attack campaign step is determined to be matched to a security incident signal when the corresponding embeddings are within a defined distance.

For example, one alert may indicate that a connection has been received from an anomalous IP address. Another alert may indicate that a particular process (application executable) is running, and that data is being retrieved from a SQL database. It is not immediately clear whether this pattern of events is highly and significantly correlated with a specific pattern described in threat intelligence, or whether it is just an anomaly—a false positive—such as a new employee connecting from their house, trying out a new password. It is difficult to balance two competing values of threat assessment—identifying and mitigating all attacks while limiting the amount of manual investigation that is required.

### Custom Telemetry Queries

In some scenarios, some but not all of the attack campaign steps of an attack campaign are matched to security incident signals. An attack campaign step may not match with a security incident signal for a number of reasons. The most basic reason is that the attack campaign step has not yet been performed—either because the activity on the computing device is innocuous or because the attacker has simply not yet performed that attack campaign step. An attack campaign step may also not match with a security incident signal because there is no security incident signal designed to match that attack campaign step. An attack campaign step may also not match with a security incident signal because thresholds applied during security incident signal identification prevent the security incident signal from being triggered. Thresholds are applied to limit false positives, but they may also reduce true positives.

In these scenarios, machine learning models may be used to generate telemetry queries to match some or all of the remaining attack campaign steps. Telemetry queries target telemetry logs directly, avoiding hard-coded thresholds or other limitations of alerts. Telemetry queries can avoid these restrictions because they do not share the same design constraints as alerts. Alerts may be generated and forwarded to users at any time, and so they are designed to be rare and certain to avoid overwhelming their human recipients. Custom generated telemetry queries have a different set of design constraints—a priority is placed on thoroughness since it is important to rule out a potential security theat. Custom generated telemetry queries run situationally, such as in response to an alert already matching an attack campaign step, so there is less opportunity to overwhelm users.

Telemetry queries may be constructed in view of the current threat context. For example, the parameters of a telemetry query may be selected based on provisional indications that an attack campaign is in progress, based on whether the target device has a vulnerability or has exhibited anomalous behavior, etc. Telemetry queries may be broader when the threat of an attack is high or narrower when the threat of an attack is low. For example, when multiple attack campaign steps already match to security incident signals there is greater confidence that an instance of an attack is underway, and so the desire to avoid false positives may be downplayed to ensure that the remaining attack campaign steps are not missed. In this scenario, a broader telemetry query is constructed, e.g., one that uses fewer and less impactful thresholds. However, if a smaller number of attack campaign steps have matched to security incident signals, or if the target device merely has a vulnerability mentioned in the attack campaign description, then a narrower telemetry query is constructed using more or more impactful thresholds.

Generating telemetry queries in view of the current threat context provides flexibility over reliance on alerts and other hard-coded security incident signals. In addition to adjusting the sensitivity of the telemetry query based on the number of attack campaign steps that have matched to security incident signals, query sensitivity may be adjusted based on a measure of significance of each attack campaign step. Furthermore, threshold amount and size are two examples of how telemetry queries may be customized, but other customizations such as querying on different telemetry entries are similarly contemplated.

### Next-Step Prediction

Once it has been determined that an instance of an attack campaign has begun, attack campaign steps of the attack that have not matched to a security incident signal or to a telemetry query result may be identified as predicted next-steps of the attack. An attack campaign step may be identified as a predicted next-step based on an ordering of the attack campaign steps-subsequent attack campaign steps that have not yet matched to a security incident signal are eligible to be a predicted next-step.

Whether an unmatched attack campaign step is identified as a predicted next step is based on how likely it is that the matched steps indicate an ongoing attack. For example, the larger the number of matched attack campaign steps, the larger the percentage of matched attack campaign steps, the more significant or difficult to accomplish are the matched attack campaign step(s), the more likely it is that the attack campaign has begun. An unmatched next-step is more likely to be identified and presented to a user the more likely it is that the attack campaign has begun.

### Alert the User

An alert is raised once a determination has been made that an attack campaign is taking place. In some configurations another ML model may be used to generate a description of the attack campaign. The description may include predicted next steps and disruption and remediation points to prevent or mitigate the attack.

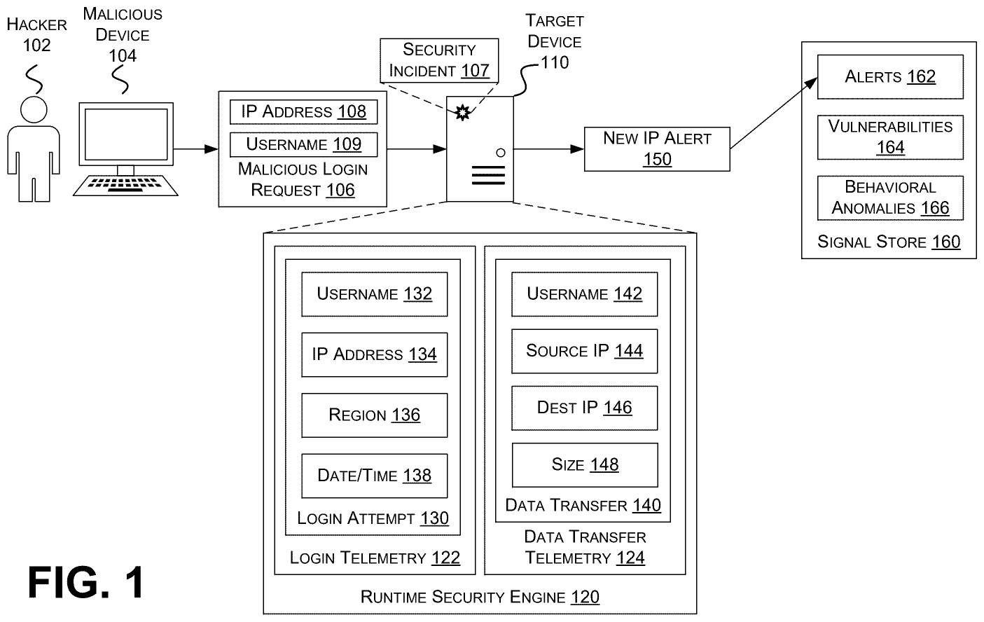

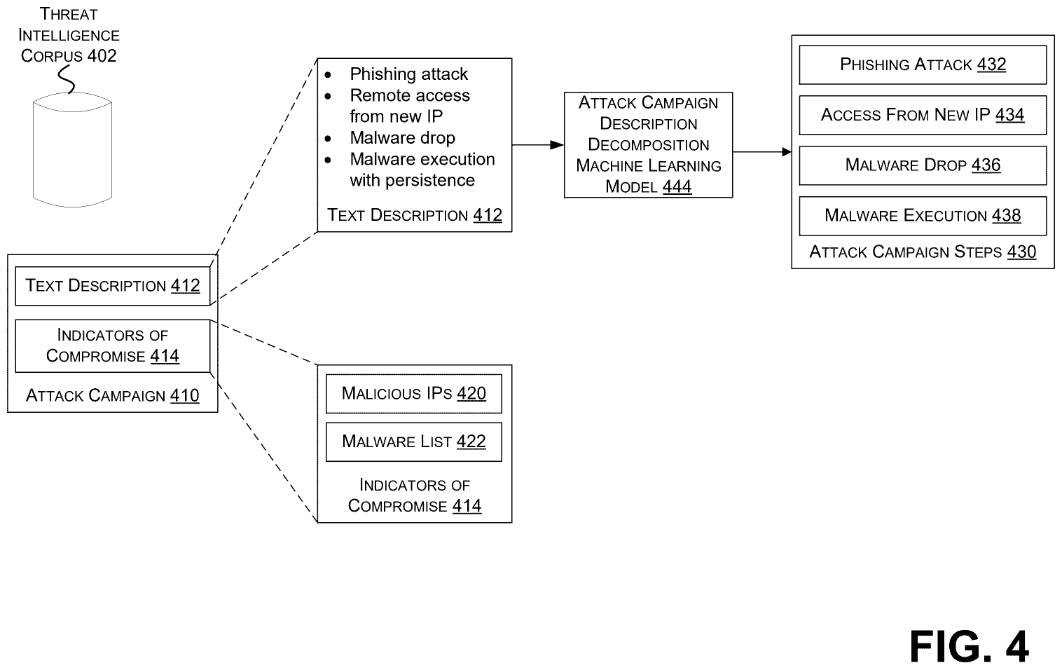

FIG. 1 illustrates generating a security incident signal. Hacker 102 operating malicious device 104 sends a malicious command to target device 110. For example, malicious device 104 may send malicious login request 106 to target device 110. Other malicious commands are similarly contemplated such as commands that destroy or exfiltrate data, initiate bank transfers, download malware, encrypt files, etc. Malicious login request 106 includes IP address 108 and username 109 as examples of properties of a malicious command. Malicious login request 106 is, or is part of, security incident 107—an intrusion, exfiltration, compromise, or other attack directed towards target device 110. Security incident 107 may be part of an instance of an attack campaign, discussed below in conjunction with FIG. 4.

In some configurations, malicious login request 106 is stored as telemetry data. Specifically, login telemetry 122 records data obtained from login requests-benign and malicious. FIG. 1 Illustrates login attempt 130, an entry in login telemetry log 122. Login attempt 130 may store username 132, IP address 134, geographic region 136, and date-time 138. As illustrated, IP address 108 of malicious login request 106 may be stored in IP address 134 while username 109 of malicious login request 106 may be stored in username 132. Data transfer telemetry 124 is another example of a telemetry log-one that stores information about data transfers to and from target device 110. Example properties of data transfer entry 140 in data transfer telemetry log 124 include file path 142, source IP 144, destination IP 146, and transfer size 148. These properties of login attempt 130 and data transfer 140 are illustrative and not limiting. Furthermore, other types of telemetry logs are similarly contemplated, such as logs of file access, exceptions thrown, processes launched, etc. Also, the number and composition of telemetry logs depicted are non-limiting-telemetry data may be stored in any combination of logs or a single log.

Runtime security engine 120 may analyze malicious login request 106, alone or in conjunction with other security incident signals, to generate a security alert. As illustrated, new IP alert 150 is an example of a security incident signal generated and stored in alerts 162 of signal store 160. Signal store 160 stores security incident signals—alerts 162, vulnerabilities 164, and behavioral anomalies 166—for future analysis. For example, signal store 160 may be searched for security incident signals that match attack campaign steps of an attack campaign.

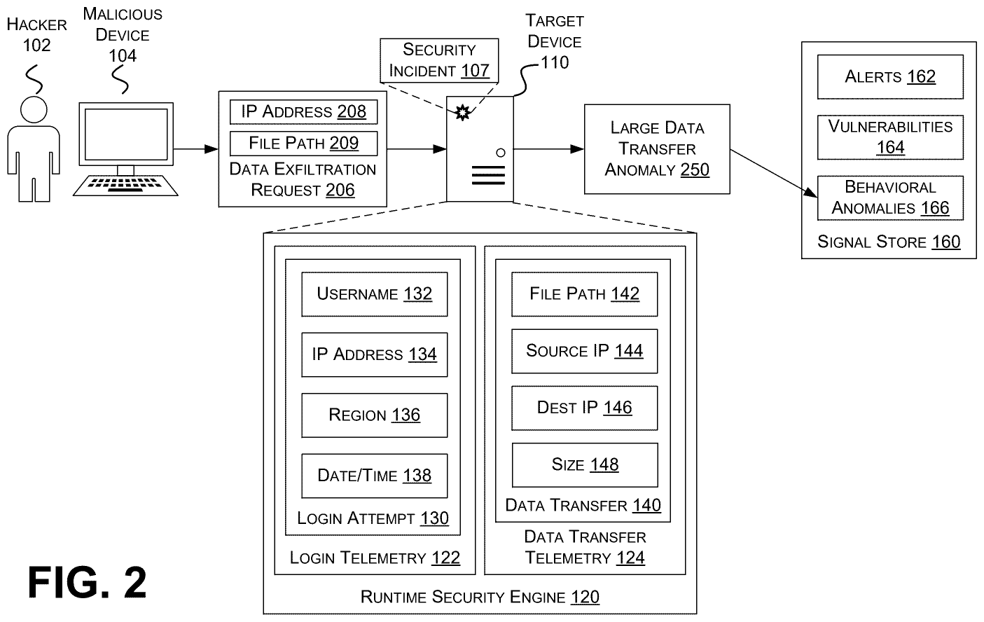

FIG. 2 illustrates detecting anomalous behavior of a target computing device. Data exfiltration request 206 is received by target device 110 from malicious device 104. Data exfiltration request 206 may include IP address 208, file path 209, and other properties applicable the data exfiltration. Data exfiltration request 206 is an example of a command that may be used in an anomalous way during security incident 107. Runtime security engine 120 may log data exfiltration request 206 in data transfer telemetry log 124. Specifically, a new data transfer entry 140 may store the source IP address 208 as source IP 144 and file path 209 as file path 142.

In response to receiving data exfiltration request 206, runtime security engine 120 may determine if one or more security incident signals are warranted. In some configurations, runtime security engine 120 analyzes telemetry logs such as login telemetry log 122 and data transfer telemetry log 124 to determine if a security incident signal should be generated. As illustrated, runtime security engine 120 determines that large data transfer anomaly 250, another example of a security incident signal, should be raised in response to data exfiltration requests 206. Large data transfer anomaly 250 is stored in behavioral anomalies 166 of signal store 160.

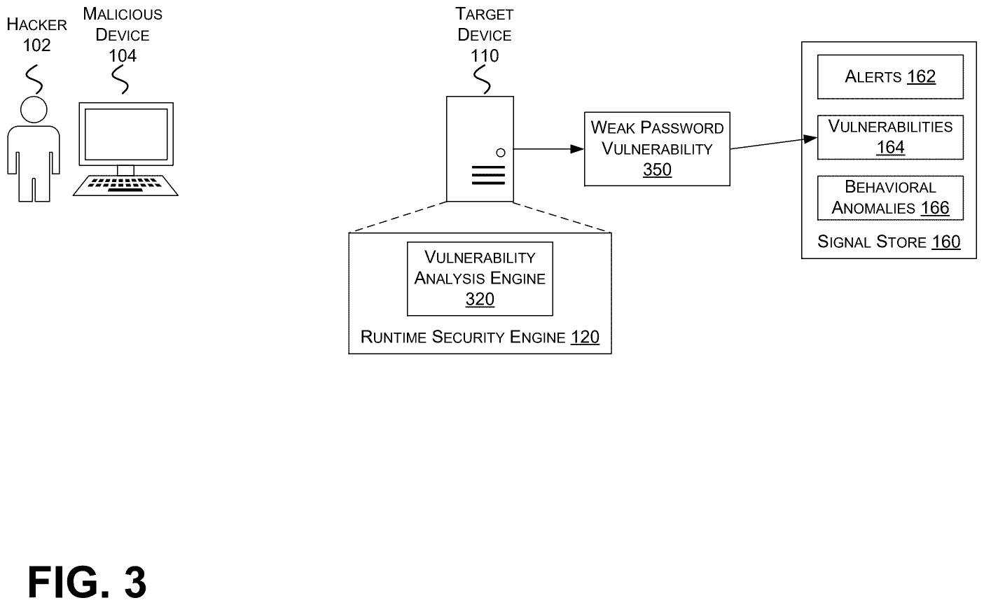

FIG. 3 illustrates detecting a vulnerability of a target computing device. Vulnerability analysis engine 320 of runtime security engine 120 detects vulnerabilities of target device 110. Vulnerabilities are configurations or states of target device 110 that leave it susceptible to attack, such as a weak password, a virtual machine that is exposed to the internet, unpatched software, etc. Unlike alerts 162, which are generated in response to potentially malicious behavior, and behavioral anomalies 166, which are generated in response to observing an operation of target device 110 that is out of the ordinary, vulnerabilities 164 represent configurations or other states of target device 110, not a particular action taken by target device 110 or request received by target device 110. For example, weak password vulnerability 350, another example of a security incident signal, is raised by vulnerability analysis engine 320 to indicate target device 110 is configured with a weak password.

FIG. 4 illustrates decomposing an attack campaign description into attack campaign steps. Threat intelligence corpus 402 represents a collection of attack campaign descriptions, optionally including indications of compromise or other structured or semi-structured data. Attack campaign 410 is one example of an entry in threat intelligence corpus 402. Attack campaign 410 may include text description 412 and indicators of compromise 414.

Text description 412 may include an expository description of an attack. As illustrated, text description 412 includes a bulleted list that includes a phishing attack, remote access from a new IP address, malware drop, and malware execution with persistence. While text description 412 includes a list, and as such is semi structured, text description 412 could also be displayed in the form of a paragraph or multiple paragraphs. Text description 412 may also include images, tabular data, and other types of data that describes an attack in a human-readable format.

Indicators of compromise 414 include malicious IP addresses for 20 and malware list for 22. Malicious IP addresses 420 may be IP addresses, IP address ranges, or other collections of IP addresses that security researchers have found to be involved in cyber-attacks. Similarly, malware list 422 is a list of viruses, spyware, key loggers, and other types of software used in a cyber-attack.

Attack campaign description decomposition machine learning model 444 is any type of machine learning model that accepts text description 412 is input and infers attack campaign steps 430 as output. Model 444 may utilize a transformer architecture, although any type of model architecture is similarly contemplated. For example, model 444 may be a large language model or a multi-modal model. Model 444 may optionally be pre trained with threat intelligence corpus 402 or other domain specific knowledge. Model 444 may be provided with text description 412, indicators of compromise 414, and a prompt that asks to infer attack campaign steps 430. As referred to herein, a model infers an output by applying a feed-forward neural network to input values.

Attack campaign steps 430 illustrate individual steps that were extracted from text description 412. As illustrated, phishing attack 432, remote access 434, malware dropped 436, and malware execution 438 are non-limiting, illustrative attack campaign steps that could be performed by a hacker executing attack campaign 410. However, any other type of hack, malicious request, or other type of attack campaign is similarly contemplated, as are other attack campaign steps. FIG. 4 illustrates extracting attack campaign steps from a semi-structured textual description, but model 444 may similarly extract attack campaign steps from non-structured expository text.

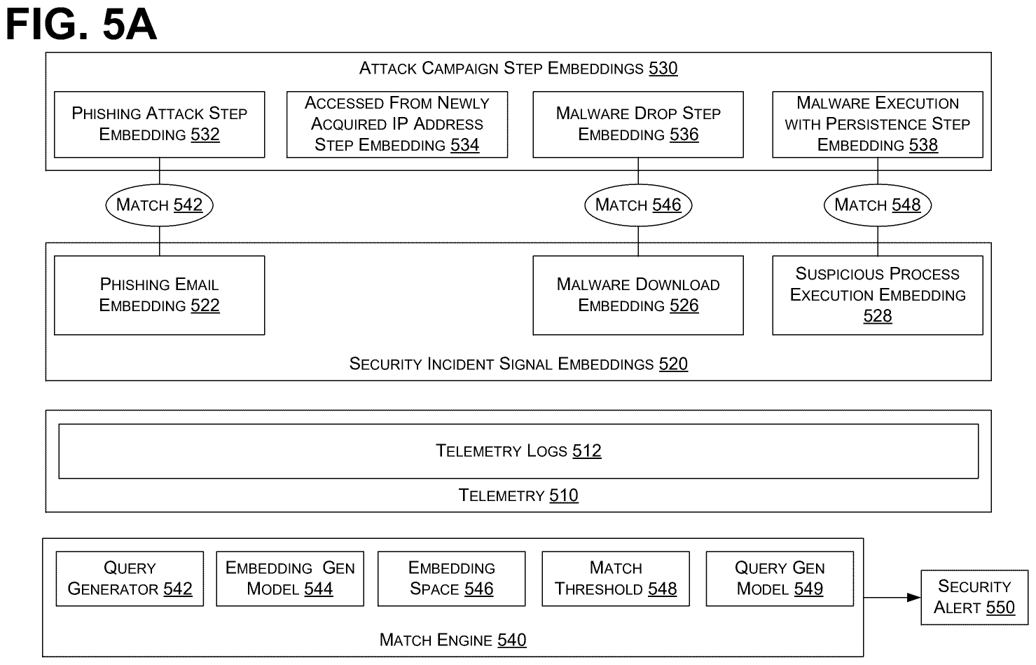

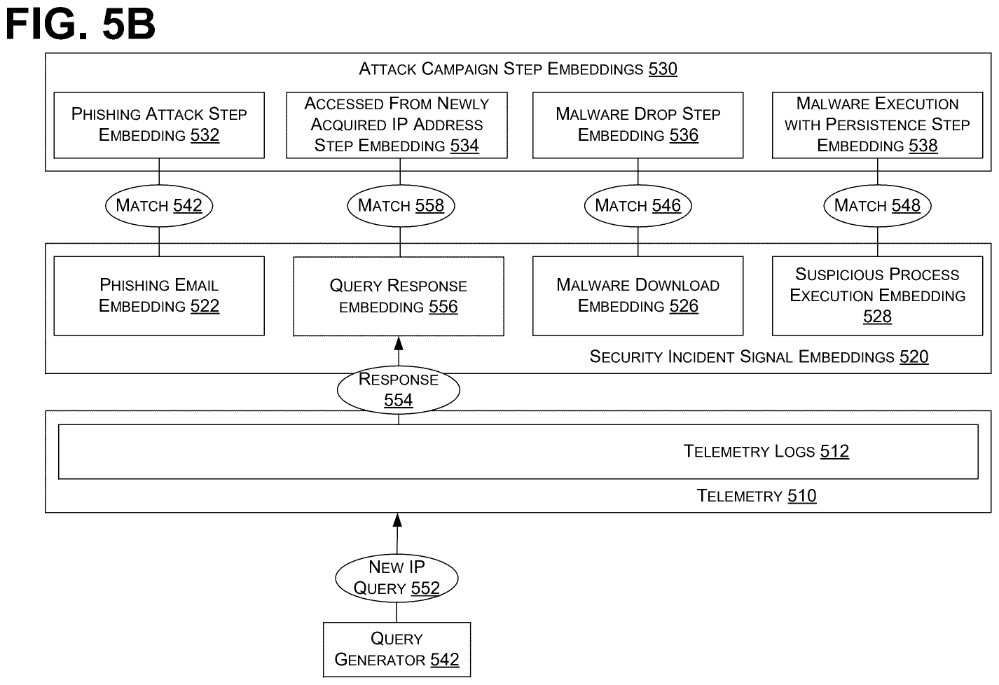

FIG. 5A illustrates matching security incident signals to attack campaign steps. FIG. 5A illustrates different levels of threat analysis. Telemetry 510 contains one or more telemetry logs 512. As discussed herein, telemetry logs 512 of telemetry 510 refer to a store of timestamped traces output by applications as they execute on target device 110.

Telemetry 510 may be analyzed by security software such as MICROSOFT DEFENDER to generate security incident signals such as new IP alert 150, large data transfer anomaly 250, and weak password vulnerability 350. Embedding generator model 544, which may also be a transformer-based large language model or any other type of machine learning model, Converts security incident signals to security incident signal embeddings 520. For example, a phishing e-mail alert may be used to infer phishing e-mail embedding 522, a malware download alert may be used to infer malware download embedding 526, and a suspicious process execution alert may be used to infer suspicious process execution embedding 528. Phishing email embedding 522, malware download embedding 526, and suspicious process execution embedding 528 are all embeddings of security incident signals identified from telemetry 510. In some configurations, security incident signal embeddings 520 are inferred from a description included in the corresponding security incident signals.

Attack campaign step embeddings 530 represent embeddings inferred by embedding generation model 544 from the individual steps of attack campaign steps 430. Specifically, phishing attack embedding 532, accessed from newly acquired IP address step embedding 534, malware dropped step embedding 536, and malware execution with persistence step embedding 538 are all examples of embeddings inferred with embedding generation model 544 from attack campaign steps 430.

As referred to herein, an embedding is a multi-dimensional vector that represents an object in an embedding space. Match engine 540 may compute a distance within embedding space 546 to determine whether security incident signal embeddings 520 can be ascribed to attack campaign step embeddings 530. A distance between embeddings may be a Euclidian distance, a cosine similarity, or other measure of distance between two vectors. A security incident signal matches with an attack campaign step if the distance between their embedding vectors is less than a defined amount. As illustrated, phishing e-mail embedding 522 matches 542 with phishing attack step embedding 532. Similarly, malware download embedding 526 matches 546 with malware drop step embedding 536 and suspicious process execution embedding 528 matches 548 with malware execution with persistence step embedding 538. In some configurations, matching three out of four attack campaign steps is within threshold 548, such that match engine 540 generates security alert 550.

In some configurations, match engine 540 makes a next step prediction of an unmatched attack campaign step. As illustrated, access from newly acquired IP address embedding 434 has not been matched with a security incident signal embedding. As such, match engine 540 may predict that access from newly acquired IP address 434 is an attack next step that should be mitigated or prevented. In this situation, security alert 550 may include an indication that “access from newly acquired IP address 434” is a potential attack next-step.

In some configurations, two or more of attack campaign steps 430 have a defined order. For example, phishing attack 432 may precede malware drop 436. This order may be defined by text description 412 of phishing attack 410. Order may be considered when determining if an unmatched attack campaign step is a predicted next-step. For example, according to the illustrated order, malware drop 436 may be a next step once phishing attack 432 has been established, but phishing attack 432 may not be a next step of malware drop 436.

FIG. 5B illustrates matching a telemetry query response to an attack campaign step. As illustrated, the attack campaign step “detecting access from a new IP address” 434 does not have a corresponding security incident signal. This may be for a number of reasons. For example, hacker 102 may be taking precautions to intentionally evade a threshold used by code that detects an “access from new IP” alert. In this situation, query generator 542 may generate a custom “accessed from newly acquired IP address query” 552 that targets telemetry logs 512 of telemetry 510. Query generator 542 may generate the custom query 552 using query generation model 549—a large language model or other transformer-based machine learning model designed to generate queries against telemetry 510. Query 552 may include different thresholds or no thresholds at all compared to code that generates an “access from new IP” alert. Model 549 may consider the current security context when generating query 552, such as increasing query breadth when there is a greater risk of an ongoing attack and narrowing query breadth when there is a lower risk of an ongoing attack.

Query 552 is provided to telemetry 510, which generates query response 554. Query response 554 may include text that describes information stored in telemetry 510 that indicates there was access from a newly acquired IP address. Often, query 552 will include a range of time that is constructed based on the times that other attack campaign steps 430 were observed.

Embedding generation model 544 may be used to infer query response embedding 556 from query response 554. Query response embedding 556 may be matched 558 with “access from newly acquired IP address” attack campaign step 534. Match 558 occurs when the embeddings 556 and 534 are within a defined distance within embedding space 546.

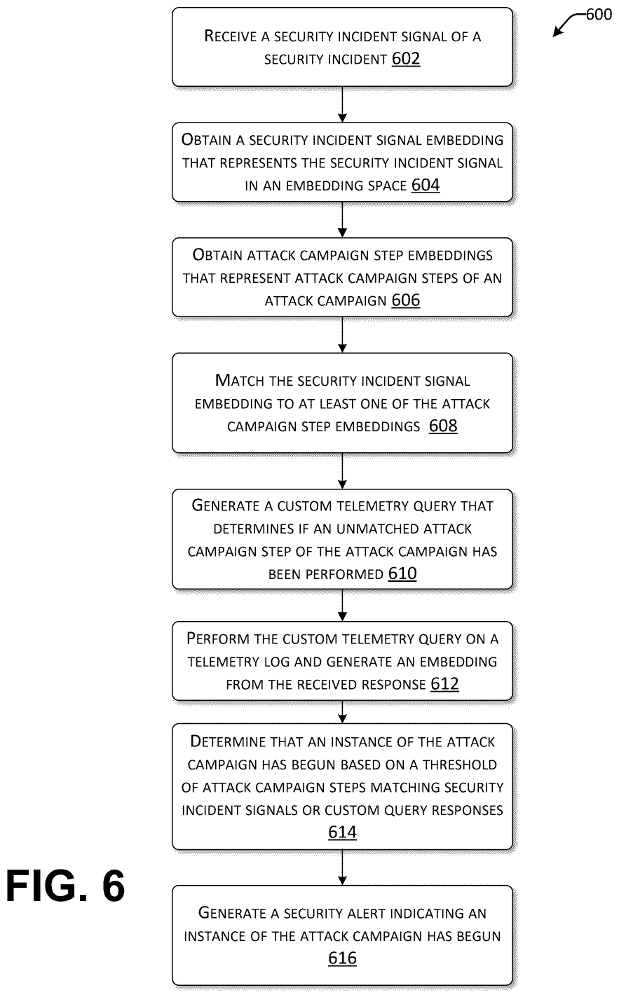

FIG. 6 is a flow diagram of an example method for automatic incident identification, investigation, and next-step prediction. Routine 600 begins at operation 602 where new IP alert 150 is received. As discussed herein, the received security incident signal may be an alert such as new IP alert 150, an indication of anomalous behavior such as large data transfer anomaly 250, or an indication of a vulnerability such as weak password vulnerability 350.

Routine 600 continues at operation 604, where phishing email embedding 522 that represents the received new IP alert 150 is obtained from embedding generation model 444.

Routine 600 continues at operation 606, where attack campaign step embeddings 530 are obtained for attack campaign steps 430 of an attack campaign 410.

Routine 600 continues at operation 608, where phishing email embedding 522 is matched to attack campaign step embedding 532.

Routine 600 continues at operation 610, where query generator 542 uses query generation model 549 to generate telemetry query 552. Query 552 analyzes telemetry 510 to determine if unmatched attack campaign step 434 has been performed without triggering an alert or other security incident signal.

Routine 600 continues at operation 612, where telemetry query 552 is performed on telemetry log 512. Custom telemetry query response 554 is received and used by embedding generation model 444 to infer query response embedding 556.

Routine 600 continues at operation 614, where a determination is made that attack campaign 410 has begun based on a determination that enough of attack campaign steps 430 match security incident signals such as new IP alert 150 or custom query responses 554 to satisfy match threshold 548.

Routine 600 continues at operation 616, where security alert 550 is generated, indicating that attack campaign 410 has begun and optionally identifying predicted next steps.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routines 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

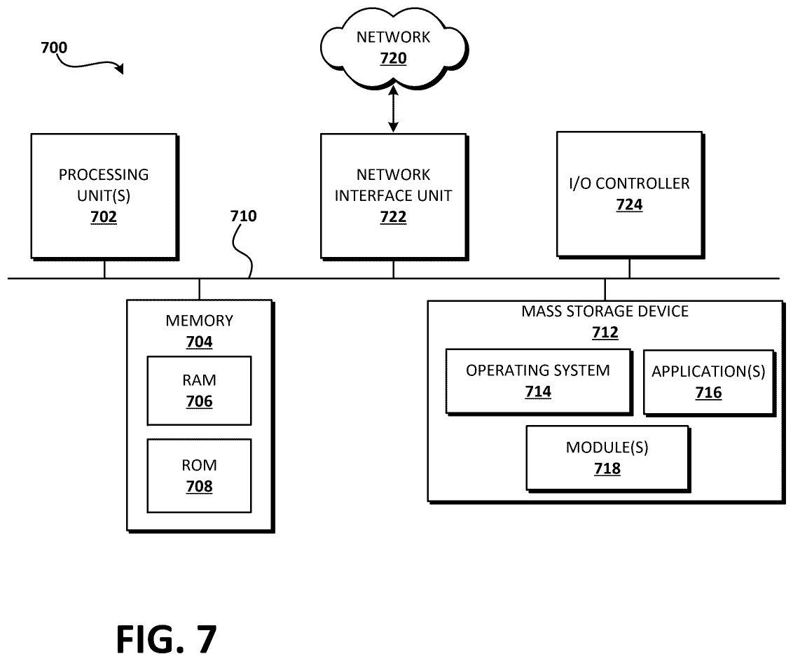

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), Neural Processing Unites (NPUs) etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The present disclosure is supplemented by the following example clauses:
Example 1: A method comprising: receiving a security incident signal; obtaining a security incident signal embedding that represents the security incident signal; obtaining a plurality of attack campaign step embeddings that represent a plurality of attack campaign steps of an attack campaign, wherein the plurality of attack campaign steps of the attack campaign are inferred from a text description of the attack campaign; matching the security incident signal embedding to one of the plurality of attack campaign step embeddings; determining that an instance of the attack campaign has begun based in part on a determination that a threshold of attack campaign step embeddings match individual security incident signal embeddings; and generating a security alert indicating that the instance of the attack campaign has begun.
Example 2: The method of Example 1, wherein the security incident signal comprises an alert that describes a potential security threat to a device.
Example 3: The method of Example 1, wherein the security incident signal comprises an indication of a vulnerable configuration of a device.
Example 4: The method of Example 1, wherein the security incident signal comprises a behavioral anomaly of a device.
Example 5: The method of Example 1, wherein the security incident signal indicates an operation performed by a computing device or a state of the computing device and wherein the plurality of attack campaign step embeddings are precomputed.
Example 6: The method of Example 1, wherein the security incident signal embedding and the plurality of attack campaign step embeddings are obtained from an embedding generation machine learning model.
Example 7: The method of Example 1, further comprising: determining that a missing attack campaign step of the plurality of attack campaign steps does not match with a security incident signal; generating a telemetry query that determines if the missing attack campaign step was performed; performing the telemetry query on a telemetry log; receiving a result of the telemetry query; obtaining a telemetry query result embedding of the result of the telemetry query; and determining that the telemetry query result embedding matches an embedding of the missing attack campaign step, wherein determining that the attack campaign has occurred on the device is based in part on a determination that the threshold of attack campaign step embeddings match individual security incident signal embeddings or individual telemetry query result embeddings.
Example 8: A system comprising: a processing unit; and a computer-readable storage medium having computer-executable instructions stored thereupon, which, when executed by the processing unit, cause the processing unit to: receive a security incident signal; obtain, from an embedding generation machine learning model, a security incident signal embedding that represents the signal in an embedding space; obtain, from the embedding generation machine learning model, a plurality of attack campaign step embeddings that represent a plurality of attack campaign steps of an attack campaign in the embedding space; match the security incident signal embedding to at least one of the plurality of attack campaign step embeddings; generate, with a query generation machine learning model, a telemetry query that determines if an unmatched one of the plurality of attack campaign steps has been performed; perform the telemetry query on a telemetry log; receive a response to the telemetry query; obtain, with the embedding generation machine learning model, a custom query response embedding from the response; determine that an instance of the attack campaign has begun based in part on a determination that a threshold of attack campaign step embeddings match individual security incident signal embeddings or individual custom query response embeddings; generate a security alert indicating that the instance of the attack campaign has begun.
Example 9: The system of Example 8, wherein the plurality of attack campaign steps are inferred by an attack decomposition machine learning model from a description of the attack campaign.
Example 10: The system of Example 8, wherein the plurality of attack campaign steps are inferred in part from structured data that describes an aspect of the attack campaign.
Example 11: The system of Example 10, wherein the structured data includes a malicious IP address, a file hash of malware, or a process name of a malicious executable.
Example 12: The system of Example 8, wherein the security incident signal comprises an alert generated in response to a query of the telemetry log.
Example 13: The system of Example 8, wherein the security incident signal comprises a first security incident signal, wherein the attack campaign is selected from a plurality of candidate attack campaigns that include attack campaign steps that match with the first security incident signal, and wherein the computer-executable instructions further cause the processing unit to: receive a second security incident signal; and remove attack campaigns that do not include attack campaign steps that match with the second security incident signal from the plurality of candidate attack campaigns.
Example 14: The system of Example 8, wherein the attack campaign is obtained from a blog post, documentation of a penetration testing tool, or a threat intelligence database.
Example 15: A computer-readable storage medium having encoded thereon computer-readable instructions that when executed by a processing unit causes a system to: obtain, from an embedding generation machine learning model, a plurality of attack campaign step embeddings that represent a plurality of attack campaign steps of an attack campaign in an embedding space, wherein the plurality of attack campaign steps of the attack campaign are inferred by an attack decomposition machine learning model from a text description of the attack campaign; generate, with a query generation machine learning model, a telemetry query that determines if an unmatched one of the plurality of attack campaign steps has been performed by a computing device; perform the telemetry query on a telemetry log; receive a response to the telemetry query; obtain, with the embedding generation machine learning model, a custom query response embedding from the response; determine that an instance of the attack campaign has begun based in part on a determination that a threshold of attack campaign step embeddings match individual custom query response embeddings; generate a security alert indicating that the instance of the attack campaign has begun.
Example 16: The computer-readable storage medium of Example 15, wherein the instructions further cause the system to: identify one of the plurality of attack campaign steps of the attack campaign that does not match a custom query response as a predicted next step.
Example 17: The computer-readable storage medium of Example 16, wherein the instructions further cause the system to: invoke an operation that protects against or prevents the predicted next step.
Example 18: The computer-readable storage medium of Example 15, wherein the instructions further cause the system to: generate an explanation of the attack campaign including an indication of executed attack campaign steps of the plurality of attack campaign steps.
Example 19: The computer-readable storage medium of Example 15, wherein the instructions further cause the system to: receive a security incident signal; and obtain, from the embedding generation machine learning model, a security incident signal embedding that represents the security incident signal in the embedding space, wherein the determination that the instance of the attack campaign has begun is based in part on a determination that the threshold of attack campaign step embeddings match individual security incident signal embeddings or individual custom query response embeddings.
Example 20: The computer-readable storage medium of Example 15, wherein an individual attack campaign step embedding matches an individual security incident signal embedding when a distance between the individual attack campaign step embedding and the individual security incident signal embedding is less than a defined distance in the embedding space.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a security incident signal;
obtaining a security incident signal embedding that represents the security incident signal;
obtaining a plurality of attack campaign step embeddings that represent a plurality of attack campaign steps of an attack campaign, wherein the plurality of attack campaign steps of the attack campaign are inferred from a text description of the attack campaign;
matching the security incident signal embedding to one of the plurality of attack campaign step embeddings;
determining that an instance of the attack campaign has begun based in part on a determination that a threshold of attack campaign step embeddings match individual security incident signal embeddings; and
generating a security alert indicating that the instance of the attack campaign has begun.

2. The method of claim 1, wherein the security incident signal comprises an alert that describes a potential security threat to a device.

3. The method of claim 1, wherein the security incident signal comprises an indication of a vulnerable configuration of a device.

4. The method of claim 1, wherein the security incident signal comprises a behavioral anomaly of a device.

5. The method of claim 1, wherein the security incident signal indicates an operation performed by a computing device or a state of the computing device and wherein the plurality of attack campaign step embeddings are precomputed.

6. The method of claim 1, wherein the security incident signal embedding and the plurality of attack campaign step embeddings are obtained from an embedding generation machine learning model.

7. The method of claim 1, further comprising:
determining that a missing attack campaign step of the plurality of attack campaign steps does not match with a security incident signal;
generating a telemetry query that determines if the missing attack campaign step was performed;
performing the telemetry query on a telemetry log;
receiving a result of the telemetry query;
obtaining a telemetry query result embedding of the result of the telemetry query; and
determining that the telemetry query result embedding matches an embedding of the missing attack campaign step, wherein determining that the attack campaign has occurred on the device is based in part on a determination that the threshold of attack campaign step embeddings match individual security incident signal embeddings or individual telemetry query result embeddings.

8. A system comprising:
a processing unit; and
a computer-readable storage medium having computer-executable instructions stored thereupon, which, when executed by the processing unit, cause the processing unit to:
receive a security incident signal;
obtain, from an embedding generation machine learning model, a security incident signal embedding that represents the signal in an embedding space;
obtain, from the embedding generation machine learning model, a plurality of attack campaign step embeddings that represent a plurality of attack campaign steps of an attack campaign in the embedding space;
match the security incident signal embedding to at least one of the plurality of attack campaign step embeddings;
generate, with a query generation machine learning model, a telemetry query that determines if an unmatched one of the plurality of attack campaign steps has been performed;
perform the telemetry query on a telemetry log;
receive a response to the telemetry query;
obtain, with the embedding generation machine learning model, a custom query response embedding from the response;
determine that an instance of the attack campaign has begun based in part on a determination that a threshold of attack campaign step embeddings match individual security incident signal embeddings or individual custom query response embeddings;
generate a security alert indicating that the instance of the attack campaign has begun.

9. The system of claim 8, wherein the plurality of attack campaign steps are inferred by an attack decomposition machine learning model from a description of the attack campaign.

10. The system of claim 8, wherein the plurality of attack campaign steps are inferred in part from structured data that describes an aspect of the attack campaign.

11. The system of claim 10, wherein the structured data includes a malicious IP address, a file hash of malware, or a process name of a malicious executable.

12. The system of claim 8, wherein the security incident signal comprises an alert generated in response to a query of the telemetry log.

13. The system of claim 8, wherein the security incident signal comprises a first security incident signal, wherein the attack campaign is selected from a plurality of candidate attack campaigns that include attack campaign steps that match with the first security incident signal, and wherein the computer-executable instructions further cause the processing unit to:
receive a second security incident signal; and
remove attack campaigns that do not include attack campaign steps that match with the second security incident signal from the plurality of candidate attack campaigns.

14. The system of claim 8, wherein the attack campaign is obtained from a blog post, documentation of a penetration testing tool, or a threat intelligence database.

15. A computer-readable storage medium having encoded thereon computer-readable instructions that when executed by a processing unit causes a system to:
obtain, from an embedding generation machine learning model, a plurality of attack campaign step embeddings that represent a plurality of attack campaign steps of an attack campaign in an embedding space, wherein the plurality of attack campaign steps of the attack campaign are inferred by an attack decomposition machine learning model from a text description of the attack campaign;
generate, with a query generation machine learning model, a telemetry query that determines if an unmatched one of the plurality of attack campaign steps has been performed by a computing device;
perform the telemetry query on a telemetry log;
receive a response to the telemetry query;
obtain, with the embedding generation machine learning model, a custom query response embedding from the response;
determine that an instance of the attack campaign has begun based in part on a determination that a threshold of attack campaign step embeddings match individual custom query response embeddings;
generate a security alert indicating that the instance of the attack campaign has begun.

16. The computer-readable storage medium of claim 15, wherein the instructions further cause the system to:
identify one of the plurality of attack campaign steps of the attack campaign that does not match a custom query response as a predicted next step.

17. The computer-readable storage medium of claim 16, wherein the instructions further cause the system to:
invoke an operation that protects against or prevents the predicted next step.

18. The computer-readable storage medium of claim 15, wherein the instructions further cause the system to:
generate an explanation of the attack campaign including an indication of executed attack campaign steps of the plurality of attack campaign steps.

19. The computer-readable storage medium of claim 15, wherein the instructions further cause the system to:
receive a security incident signal; and
obtain, from the embedding generation machine learning model, a security incident signal embedding that represents the security incident signal in the embedding space, wherein the determination that the instance of the attack campaign has begun is based in part on a determination that the threshold of attack campaign step embeddings match individual security incident signal embeddings or individual custom query response embeddings.

20. The computer-readable storage medium of claim 15, wherein an individual attack campaign step embedding matches an individual security incident signal embedding when a distance between the individual attack campaign step embedding and the individual security incident signal embedding is less than a defined distance in the embedding space.
